(19) United States
(12) Patent Application Publication
(10) Pub. No.: US 2005/0011546 A1
(43) Pub. Date: Jan. 20, 2005

(54) Movement reversal device, particularly for a dishwasher

(75) Inventors: Roland Ertle, Lauingen (DE); Claus Kother, Niederstotzingen (DE); Michael Rosenbauer, Reimlingen (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/873,445

(22) Filed: Jun. 21, 2004

Related U.S. Application Data
(63) Continuation of application No. PCT/EP02/13255, filed on Nov. 25, 2002.

(30) Foreign Application Priority Data
Dec. 21, 2001 (DE) 101 63 181.2

(51) Int. Cl. B08B 3/02

(52) U.S. Cl. 134/191; 134/56 D; 134/172; 134/178

(57) ABSTRACT

A movement reversal device is used in a dishwasher. The dishwasher contains a washing receptacle which is provided with at least two spraying devices impinging upon goods to be washed that are disposed in the washing receptacle by a fluid transported via a circulating pump. The transported fluid flows through the movement reversal device that contains at least two outlets for feeding different spraying devices with the fluid. The outlets can be opened or closed in such a way by a positioning element that one or several or all outlets are open or closed one after another and/or continuously. In order to produce the movement reversal device in such a way that the actions of the electronically regulated revolution speed of the circulating pump can be replaced in a simple manner, the positioning element is provided with at least one opening with a diameter that is different from the diameter of at least one other opening.

### CROSS-REFERENCE TO RELATED APPLICATION

This application is a continuation, under 35 U.S.C. § 120, of copending international application No. PCT/EP02/13255, filed Nov. 25, 2002, which designated the United States; this application also claims the priority, under 35 U.S.C. § 119, of German patent application No. 101 63 181.2, filed Dec. 21, 2001; the prior applications are herewith incorporated by reference in their entirety.

### BACKGROUND OF THE INVENTION

### FIELD OF THE INVENTION

The present invention relates to a movement reversal device, in particular for a dishwashing machine with a washing receptacle having at least two spraying devices. The spraying devices, supply goods to be washed disposed in the washing receptacle, with a liquid initially conveyed by a circulating pump. The conveyed liquid flows through the movement reversal device, and the movement reversal device has at least two outlets for feeding the liquid to different spraying devices in each case. The outlets can be opened or closed by a positioning element such that in each case either one of the outlets or a number of outlets or all outlets can be opened or closed one after another and/or continuously.

Published, Non-Prosecuted German Patent Application DE 198 57 103 A1, corresponding to U.S. Pat. No. 6,601,593, discloses a movement reversal device of the type initially described, in which the positioning element is a rotary slide valve disposed in a flow heater, which in reverse direction in each case has a closed area after an open area, between which there is an unfilled distance. The above-mentioned open area is a circular opening.

Controlling the rotary slide valve disclosed in DE 198 57 103 A1. can be managed for example with an actuating mechanism known from Published, Non-Prosecuted German Patent Application DE 100 65 571 A1, which contains a motor-driven cam plate connected solidly to the rotary slide valve.

Published, Non-Prosecuted German Patent Application DE 199 07 158 A1 reveals that the revolution speed of the circulating pump can be regulated, whereby in Published, Non-Prosecuted German Patent Application DE 199 07 188 A1 it is suggested to avoid heightened noise when exchanging the spraying devices, to reduce the revolution speed of the circulating pump when changing the spraying devices, and whereby in the above-mentioned Published, Non-Prosecuted German Patent Application DE 198 57 103 A1 and also in Published, Non-Prosecuted German Patent Application DE 199 07 157 A1 it is specified to configure the revolution speed of the circulating pump when operating a lower spraying device higher than when operating an upper spraying device, to ensure full usage of the filled quantity of liquid.

The electronic regulation of the revolution speed of the circulating pump is expensive. When the revolution speed is throttled back more noise is produced than with normal revolution speed.

### SUMMARY OF THE INVENTION

It is accordingly an object of the invention to provide a movement reversal device, particularly for a dishwasher that overcomes the above-mentioned disadvantages of the prior art devices of this general type, with which the effects of electronic regulation of the revolution speed of the circulating pump can be replaced in a simple manner.

With the foregoing and other objects in view there is provided, in accordance with the invention, a movement reversal device through which a liquid flows. The movement reversal device is used in combination with a dishwashing machine. The dishwasher has a circulating pump for conveying a liquid and a washing receptacle with at least two spraying devices further conveying the liquid for cleaning goods disposed in the washing receptacle. The movement reversal device contains at least two outlets for supplying the liquid to different ones of the spraying devices, and a positioning element for opening or closing the outlets such that in each case either one of the outlets, a number of the outlets, or all of the outlets are opened or closed alternately one after another and/or continuously. The positioning element has at least two openings including a first opening and a second opening having a different cross-section compared to a cross-section of the first opening.

The task is solved according to the present invention by the positioning element having the first opening with a different cross-section compared to the second opening.

Due to at least a smaller opening a possibility of conveying a lesser quantity liquid to a desired spraying device is created in a simple manner, corresponding to the effect of a reduction in the revolution speed of the circulating pump according to the above described prior art. With an at least larger opening a possibility is created in a simple manner of conveying a larger quantity of liquid to a desired spraying device, corresponding to the effect of boosting the revolution speed of the circulating pump compared to the above mentioned reduced revolution speed of the circulating pump according to the above described prior art. Accordingly, the effects of electronic regulation of the revolution speed of the circulating pump can be substituted by simple mechanical measures. With the invention there has been success in creating a movement reversal device of the type initially described, in which the effects of electronic regulation of the revolution speed of the circulating pump according to the prior art can be substituted in a simple manner and thus the above mentioned disadvantages of the prior art can be avoided.

According to a preferred embodiment of the invention the first opening with a different cross-section compared to the second opening has a substantially lesser cross-section. This measure creates the possibility of substituting a substantial reduction in the revolution speed of the circulating pump according to prior art in a simple manner.

According to a preferred embodiment of the invention the first opening with the substantially lesser cross-section compared to the second opening serves to supply the liquid to an upper spraying device. The substantial reduction in the revolution speed of the circulating pump made according to the prior art serves to lower the working point of the circulating pump to the extent that the latter can be operated without dry running with the quantity of liquid available for circulating decreased on account of the quantity of liquid found in the longer supply of liquid to the upper spraying device, the so-called dead water quantity.

Due to the first opening assigned to the supply of liquid to an upper spraying device with the substantially lesser cross-section compared to the second opening, use of the above described substantial reduction in the revolution speed of the circulating pump is created according to the prior art in a simple manner

According to another preferred embodiment of the invention the positioning element is a disc, which has the first opening with the substantially lesser cross-section compared to the second opening. Configuring the inventive movement reversal device as a disc is the simplest option for reversing the inventive movement reversal device.

The at least one larger second opening appropriately acts substantially as the supplier for liquid to a lower spraying device, but alternatively can also serve as the supplier for liquid to the upper spraying device. Because the opening assigned to supply the liquid to the lower spraying device has a substantially larger cross-section compared to the at least one smaller (first) opening, its use substantially increases the revolution speed of the circulating pump. By adjusting the above mentioned movement reversal device in which all outlets are opened alternately one after another and/or continuously, substitution of the reduction in the revolution speed of the circulating pump according to the prior art is not necessary, since there is an adequate store of liquid and dry running of the circulating pump cannot occur. Using the at least one larger second opening alternatively for supplying the upper spraying device, substitutes for the above described control of the revolution speed of the circulating pump in a simple manner.

For the above-described application, in which all outlets of the inventive movement reversal device are opened alternately one after another and/or continuously, preferably two larger second openings opposite one another on the disc serve as simultaneous supply of liquid to a lower and an upper spraying device. By using a varying quantity of liquid for the different modes of the spraying device, only the upper spraying device, only the lower spraying device, and both spraying devices, the variability in the wash cycle control is thus increased.

According to a preferred embodiment of the invention, closed areas of the positioning element, which rest sealed in locked positions on the corresponding outlets, in each case have a revolving sealing edge, projecting up in the direction of the outlets. Also, according to a further preferred embodiment of the invention the smaller first opening is enclosed by a sealing edge projecting up in the direction of the outlets. This measure easily guarantees a thorough sealing bearing on the corresponding outlets.

Other features which are considered as characteristic for the invention are set forth in the appended claims.

Although the invention is illustrated and described herein as embodied in a movement reversal device, particularly for a dishwasher, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 a schematic representation of a domestic dishwashing machine;

FIG. 2 is a diagrammatic, side-sectional view of a flow heater with a movement reversal device according to the invention;

FIG. 3 is a diagrammatic, top-sectional view of the flow heater with a preferred embodiment of the movement reversal device taken along the line III-III shown in FIG. 2;

FIGS. 4A-4D are diagrammatic, plan views of possible positions of a positioning element of a first embodiment of the movement reversal device; and

FIGS. 5A-5D are diagrammatic, plan views of possible positions of the positioning element of a second embodiment of the movement reversal device.

### DESCRIPTION OF THE PREFERRED EMBODIMENTS

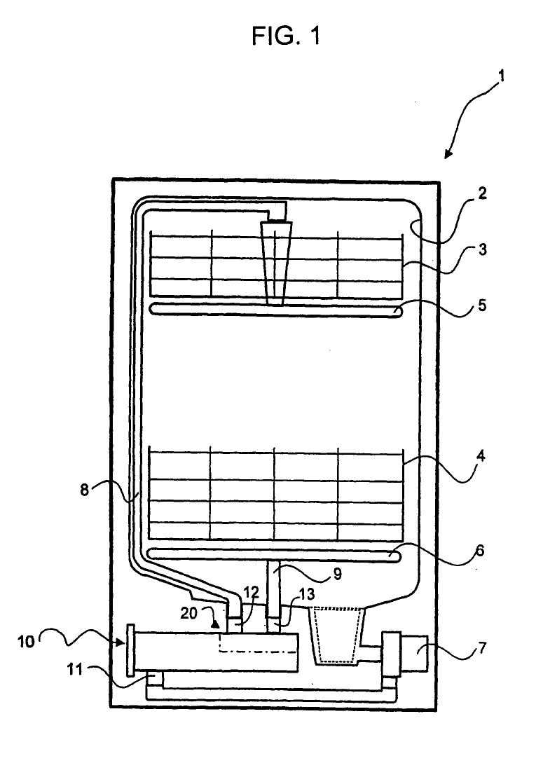

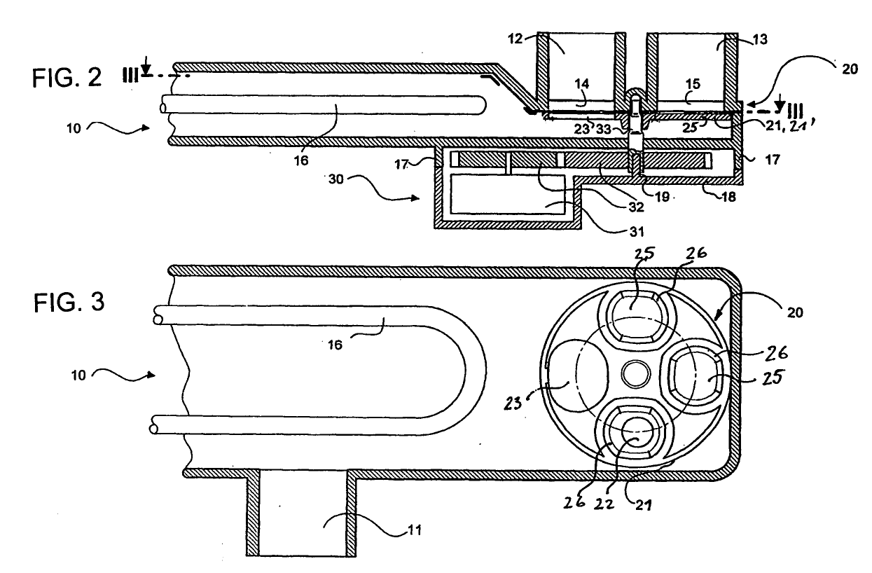

Referring now to the figures of the drawing in detail and first, particularly, to FIG. 1 thereof, there is shown an inventive movement reversal device explained in an application for a domestic dishwashing machine 1. The domestic dishwashing machine 1, not described in greater detail here, has a washing receptacle 2, in which goods to be washed, e.g. dirty dishes and cutlery, are placed, usually into dish racks 3, 4. Disposed in the washing receptacle 2 are, according to the present invention, at least two spraying devices, in the illustrated embodiments two spraying devices 5, 6, which supply the goods to be washed disposed in the washing receptacle 2 with a liquid. The liquid, usually called dishwashing liquid, is conveyed to the spraying devices 5, 6 in liquid supply lines 8, 9 by a circulating pump 7. Normally, the liquid conveyed in the domestic dishwashing machine 1 is heated at least in a part program segment of a wash cycle, for which purpose the domestic dishwashing machine 1 in the illustrated embodiments has a flow heater 10. The liquid conveyed in the domestic dishwashing machine 1 is forwarded by the circulating pump 7 to a supply connection 11 of the flow heater 10 and through the flow heater 10. The flow heater 10 has at least two outlet connections, namely a number of outlet connections corresponding to the number of spraying devices or simultaneously operated groups of spraying devices, in the illustrated embodiments two outlet connections 12, 13. The liquid is conveyed via the above-mentioned liquid supply lines 8, 9 to the different spraying devices 5, 6 from the outlet connections 12, 13 of the flow heater 10. The heating rods required to heat the liquid in the flow heater 10 are designated by reference numeral 16 (FIG. 2).

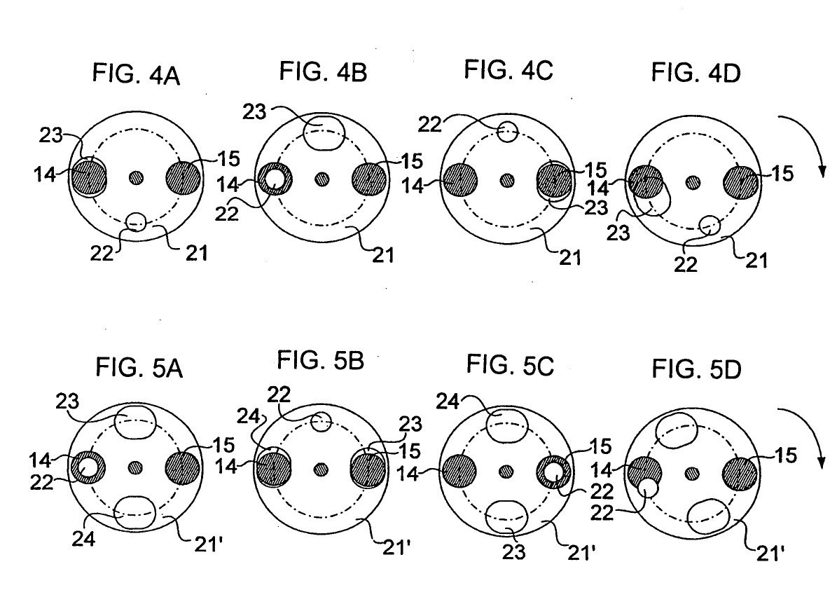

The conveyed liquid flows through a movement reversal device 20, disposed in the illustrated embodiments in the flow heater 10, for which purpose the conveyed liquid is forwarded by the circulating pump 7 to the supply connection 11 of the flow heater 10, which is thus also the supply connection for the movement reversal device 20. The movement reversal device 20 has at least two outlets, in the illustrated embodiment the two outlet connections 12, 13 of the flow heater 10, for the supply of liquid in each case to different spraying devices 5, 6. The outlet connections 12, 13 can be opened or substantially closed by a positioning element 21, 21′ of the movement reversal device 20 disposed in the illustrated embodiments in the flow heater 10, in the direction of flow in front of the outlet connections 12, 13, such that in each case either one of the outlet connections 12, 13 or a number of outlet connections 12, 13 or all outlet connections 12, 13 are opened or substantially closed alternately one after another and/or continuously. For this, the positioning element 21, 21′ of the movement reversal device 20, configured in the illustrated embodiments as a disc, is disposed in the direction of flow in front of each outlet connection 12, 13 of upstream outlets 14, 15 of the flow heater 10. In the illustrated preferred embodiment according to FIGS. 3 and 4A-4D one of the outlets 14, 15 of the flow heater 10 can be closed off by the positioning element 21 in each case, and the two outlets 14, 15 can be opened or substantially closed either alternately one after another and/or continuously by the positioning element 21′ in the illustrated other embodiment according to FIGS. 5A-5D.

According to the invention, the positioning element 21, 21′ has at least one opening 22 with a different cross-section compared to the cross-section of another opening 23. The at least one opening 22 with the different cross-section has, compared to the cross-section of the other opening 23, a substantially lesser cross-section. A possibility is created in a simple manner with the invention by at least a smaller opening 22 for conveying a lesser quantity of liquid to a desired spraying device 5, 6, corresponding to the effect of a reduction in the revolution speed of the circulating pump 7 according to the above-described prior art. A possibility is created in a simple manner with the invention with the larger opening 23, 24. The larger opening 23, 24 conveys a larger quantity of liquid to a desired spraying device 5, 6, and corresponds to the effect of boosting the revolution speed of the circulating pump compared to the above-mentioned reduced revolution speed of the circulating pump 7. Thus the effects of electronic regulation of the revolution speed of the circulating pump 7 can be replaced by simple mechanical measures. Using the present invention success has been found in producing a movement reversal device 20 of the type mentioned at the outset, in which the effects of electronic regulation of the revolution speed of the circulating pump 7 according to the prior art can be replaced in a simple manner, and with which the initially specified disadvantages of the prior art can be avoided.

In the illustrated embodiments the opening 22 with the substantially lesser cross-section-hereinafter referred to as the smaller opening 22, compared to the at least one further opening 23, hereinafter referred to as the larger opening 23, serves to supply the liquid to an upper spraying device 5. The substantial reduction in revolution speed of the circulating pump made according to the prior art serves to lower the operating point of the circulating pump 7 to the extent that the latter can be operated without dry running on the quantity of liquid available for circulating being reduced on account of the quantity of liquid in the longer supply of liquid to the upper spraying device 5, the so-called dead water quantity. Due to the supply of liquid to the upper spraying device 5 being controlled by the smaller opening 22 with the substantially lesser cross-section compared to the at least one further opening 23, substitution is made in a simple manner according to the prior art of the above-described substantial reduction in the revolution speed of the circulating pump.

The openings 22, 23 are disposed in the illustrated embodiments at a right angle to one another on a circle with the same radius indicated in FIG. 3 by dashed lines. The configuration of the openings on the same radius at a right angle to one another creates a very simple possibility of controlling the movement reversal device. In the illustrated embodiments the at least one larger opening 23 serves to supply the liquid to a lower spraying device 6, although with particular program cycles the latter can also alternatively serve to supply the liquid to the upper spraying device 5. Through the opening 23 assigned to supply the liquid to a lower spraying device 6 with the substantially larger cross-section compared to the at least one smaller opening 22 a substitution is made in a simple manner of the above-described substantial increase in the revolution speed of the circulating pump according to the prior art. In adjusting the above-mentioned movement reversal device in which all outlets 14, 15 are opened alternately one after another and/or continuously, the substitution of the reduction in revolution speed of the circulating pump 7 according to the prior art is not necessary, because there is enough liquid supply, and dry running of the circulating pump 7 cannot thus occur. Substitution of the above-described control of the revolution speed of the circulating pump 7 according to the prior art is made in a simple manner by using the at least one large opening 23 alternatively also for supplying the upper spraying device 6.

In the further embodiment illustrated in FIGS. 5A-5D two opposite, larger openings 23, 24 on the positioning element 21′, the disc, act as simultaneous supplies of liquid to the lower spraying device 6 and to the upper spraying device 5.

The closed regions of the positioning element 21, 21′, the disc, which in the locked positions rest tight on the corresponding outlets 14, 15, are designated by 25 and in each case have a revolving sealing edge 26 projecting up in the direction of the outlets 14, 15 (FIG. 3). Also, the smaller opening 22 is enclosed by such a sealing edge 26. This measure guarantees a thorough sealing bearing on the corresponding outlets 14, 15 in a simple manner.

The drive unit 30 is a motor 31, e.g. an electromotor, with gears 32, illustrated only schematically in FIG. 2, e.g. a toothed gearing. The control element 21 is connected to the gears 32 by a shaft 33, which is guided in the housing of the flow heater 10. The motor 30 and the gears 32 are protected by a cover 18 sitting on a folded-up edge 17 of the flow heater 10. The cover 18 also has bearings for the gears 32, of which only one folded-up bearing journal 19 is illustrated, as bearing for the shaft 33.

Herein below the function of the inventive movement reversal device 20 is explained for both illustrated embodiments.

First comes the description of the function of the first preferred embodiment of the inventive movement reversal device 20 with the positioning element 21.

With the positioning element 21 of the preferred embodiment of the inventive movement reversal device 20 according to FIGS. 3 and 4A-4D in each case either one of the outlets 14, 15 is opened alternately one after another and/or continuously, or substantially held closed.

If the aim is to supply the spraying devices 5, 6 with a reduced quantity of liquid to the upper spraying device 5, then the motor 31 of the drive device 30 is connected to the supply voltage by a program control device of the domestic dishwashing machine 1, not shown in greater detail here, and the positioning element 21 begins to turn clockwise, as indicated by an arrow in FIG. 4D. One of the closed areas 25 of the positioning element 21 is turned until it sits tight on the outlet 15 and the smaller opening 22 lies over the outlet 14. This corresponds to the position of the positioning element 21 in FIG. 4B. In the process the supply of liquid flowing through the flow heater 10 in this case to the lower spraying device 6 is interrupted and the supply to the upper spraying device 5 is opened on account of the smaller opening 22 with less liquid throughput. The movement reversal device 20 remains in this position for an effective period provided in the program cycle, approximately one minute in the illustrated embodiment, whereby the location of the positioning element 21 is fixed by a sensory mechanism, not described in greater detail here, e.g. the actuator mechanism described in Published, Non-Prosecuted German Patent Application DE 100 65 571 A1 which is incorporated by reference herein, and the motor 31 is switched off by the program control device for a preset duration, so that the respective location of the positioning element 21 is maintained for this duration.

With selective supplying of the spraying devices 5, 6 the motor 31 turns further, by which one of the closed areas 25 sits tight on the outlet 14 after a revolution of the positioning element 21 through 90° in the embodiment and the larger opening 23 lies over the outlet 15. This corresponds to the position of the positioning element 21 in FIG. 4C. Supply to the upper spraying device 5 is now interrupted and supply is opened to the lower spraying device 6 with a large liquid throughput. In this position the movement reversal device 20 now remains for an effective period provided in the program cycle, approximately one minute in the illustrated embodiment. However, subsequent continuous further rotation of the motor 31 to the position in FIG. 4B, in the illustrated embodiment over 270°, quickly results in opening of the outlet 15 by the smaller opening 22 on account of the rapid rotation of the positioning element 21, and then in opening of the outlet 14 by the larger opening 23 (see FIG. 4D and then FIG. 4A), until one of the closed areas 25 rests on the outlet 15 and the smaller bore 22 on the outlet 14, with the procedure being repeated as above. As described initially, selective charging of the spraying devices 5, 6 is used especially to save water, whereby according to the present invention the smaller opening 22 of the positioning element 21 of the inventive movement reversal device 20 prevents intake of air according to the prior art with unpleasant and unwanted noise from the circulating pump 7 by lesser liquid throughput to the upper spraying device 5, such that empty suction of the suction chamber of the circulating pump 7 does not occur, and thus a decrease in the revolution speed of the circulating pump 7 is not necessary, as in the prior art.

But now if selective charging of the spraying devices 5, 6 with an unchecked liquid supply to the upper spraying device 5 is wanted, the positioning element 21 is turned until one of the closed areas 25 of the positioning element 21 sits tight on the outlet 15, and the larger opening 23 lies over the outlet 14. This corresponds to the position of the positioning element 21 shown in FIG. 4A. Accordingly the charging of the liquid flowing through the flow heater 10 in this case to the lower spraying device 6 is interrupted and the supply to the upper spraying device 5 is opened due to the larger opening 23 with unreduced liquid throughput. The movement reversal device 20 remains in this position for an effective period provided in the program sequence, approximately one minute in the illustrated embodiment. With selective charging of the spraying devices 5, 6 the motor 31 then rotates further, but at the same time, on account of the rapid revolution of the positioning element 21, this quickly results in further opening of the outlet 14 by the smaller opening 22 (see FIG. 4B). After rotation of the positioning element 21 through 180° in the embodiment one of the closed areas 25 sits tight on the outlet 14, and the larger opening 23 lies over the outlet 15. This corresponds to the position of the positioning element 21 in FIG. 4C. Accordingly, supply to the upper spraying device 5 is interrupted and supply to the lower spraying device 6 with the larger liquid throughput is opened. The movement reversal device 20 now remains in this position for an effective period provided in the program sequence, approximately one minute in the illustrated embodiment. With subsequent continuous further rotation of the motor 31 to the position in FIG. 4A, in the illustrated embodiment again through 180°, until one of the closed areas 25 again bears on the outlet 15 and the larger bore 23 lies on the outlet 14, and the procedure continues as above.

But if continuous opening only of the liquid supply line 8 to the upper spraying device 5 with an undiminished quantity of liquid is wanted, so-called complete upper rack washing, then the above-described sensory mechanism is employed to run the motor 31 only until the larger opening 23 of the positioning element 21 has reached the outlet 14 for the outlet connection 12 to the liquid supply line 8 to the upper spraying device 5, see FIG. 4A, and then to maintain this position throughout the entire wash cycle, because the motor 31 is no longer being run.

If continuous opening only of the liquid supply line 8 to the upper spraying device 5 is wanted, though with reduced quantity of liquid, so-called choked upper rack washing, then the above-described sensory mechanism is employed to run motor 31 only until the larger opening 23 of the positioning element 21 has only partially opened the outlet 14 for the outlet connection 12 to the liquid supply line 8 to the upper spraying device 5, see FIG. 4D, and then to maintain this position throughout the entire wash cycle, because the motor 31 is no longer being run.

But if continuous opening only of the liquid supply line 8 to the upper spraying device 5 is wanted, though with the reduced quantity of liquid during selective operation, a so-called strongly choked upper rack washing, then the above-described sensory mechanism is employed to run the motor 31 only until the smaller opening 22 of the positioning element 21 has opened the outlet 14 for the outlet connection 12 to the liquid supply 8 to the upper spraying device 5, see FIG. 4B, and then to maintain this position throughout the entire wash cycle, because the motor 31 is no longer being run.

Of course, it is also conceivable to alternatively carry out continuous opening only of the liquid supply line 9 to the lower spraying device 6. With the above-described sensory mechanism the motor 31 would run only until the larger opening 23 of the positioning element 21 has reached the outlet 15 for the outlet connection 13 to the liquid supply line 9 to the lower spraying device 6, see FIG. 4C, and then, because the motor 31 would no longer be run, would maintain this position throughout the complete wash cycle.

Simultaneous operation of both spraying devices 5, 6, the so-called dual rack washing, is not provided with the first preferred embodiment of the inventive movement reversal device 20.

The description of the function of the second embodiment of the inventive movement reversal device 20 with the positioning element 21′ now follows.

With the positioning element 21′ of the second embodiment of the inventive movement reversal device 20 according to FIGS. 5A-5D in each case either one of the outlets 14, 15 or both outlets 14, 15 is opened or held substantially closed alternately one after another and/or continuously.

If selective charging of the spraying devices 5, 6 is wanted, then the connection of the motor 31 of the drive mechanism 30 to the supply voltage by a program control device of the domestic dishwashing machine 1, not explained in greater detail here, is made, and the positioning element 21′ begins to revolve clockwise, as indicated by an arrow in FIG. 5D. Thereby one of the closed areas 25 of the positioning element 21′ is rotated until it is sitting tight on the outlet 15, and the smaller opening 22 lies over the outlet 14. This corresponds to the position of the positioning element 21 in FIG. 5A. Thus the supply of liquid flowing through the flow heater 10 liquid in this case to the lower spraying device 6 is interrupted, and the supply to the upper spraying device 5 is opened. The movement reversal device 20 remains in this position, for approximately one minute in the illustrated embodiment, whereby the location of the positioning element 21 is fixed by a sensory mechanism, not described in greater detail here, and the motor 31 is switched off by the program control device for a preset duration, so that each location of the positioning element 21′ is kept throughout this duration.

But subsequent continuous further rotation of the motor 31 to the position in FIG. 5C, in the illustrated embodiment through 180°, in which one of the closed areas 25 sits tight on the outlet 14 and the smaller opening 22 lies over the outlet 15, temporarily and quickly results in the opening of both outlets 14, 15 by the larger openings 23, 24 (see FIG. 5B) due to the rapid rotation of the positioning element 21′. Supply to the upper spraying device 5 is interrupted in the position of the positioning element 21′ according to FIG. 5C, and supply to the lower spraying device 6 is opened. The movement reversal device 20 remains in this position, again for approximately one minute in the illustrated embodiment.

But subsequent further rotation of the motor 31 to the position according to FIG. 5A, in the illustrated embodiment through 180°, in which one of the closed areas 25 sits tight on the outlet 15 and the smaller opening 22 lies over the outlet 14, quickly results in opening of both outlets 14, 15 by the larger openings 23, 24 (see FIG. 5D) due to the rapid rotation of the positioning element 21′. Supply to the lower spraying device 6 is interrupted in the position of the positioning element 21′ according to FIG. 5A, and supply to the upper spraying device 5 is opened. The movement reversal device 20 remains in this position, again for approximately one minute in the illustrated embodiment, and then the procedure is repeated, as above.

But if continuous opening only of the liquid supply 8 to the upper spraying device 5 is wanted, the so-called choked upper rack washing, then the above-described sensory mechanism is employed to run the motor 31 only until the smaller opening 22 of the positioning element 21′ has reached the outlet 14 for the outlet connection 12 to the liquid supply line 8 to the upper spraying device 5, see FIG. 5A, and then to maintain this position throughout the entire wash cycle, because the motor 31 is no longer being run.

If continuous opening only of the liquid supply line 8 to the upper spraying device 5 is wanted, though with reduced quantity of liquid, the so-called strongly choked upper rack washing, then the above-described sensory mechanism is employed to run the motor 31 only until the smaller opening 22 of the positioning element 21′ has only partially opened outlet 14 for the outlet connection 12 to the liquid supply line 8 to the upper spraying device 5, see FIG. 5D, and then to maintain this position throughout the entire wash cycle, because the motor 31 is no longer being run.

The so-called complete upper rack washing is not provided in this further embodiment.

If, alternatively, continuous opening only of the liquid supply line 9 to the lower spraying device 6 were now wanted, then the above-described sensory mechanism would be used to run the motor 31 only until the smaller opening 22 of the positioning element 21′ has reached the outlet 15 for the outlet connection 13 to the liquid supply 9 to the lower spraying device 6, see FIG. 5C, and then to maintain this position throughout the entire wash cycle, because the motor 31 is no longer being run.

If uninterrupted operation of both spraying devices 5, 6 is wanted in the other embodiment of the inventive movement reversal device 20, the position of the openings 23 and 24 on the positioning element 21′ at both outlets 14, 15 can again be fixed by the above-described sensory mechanism (see FIG. 5B) and this position is maintained throughout the entire wash cycle, as the motor 31 is no longer being operated. The filling quantity with washing liquid is increased correspondingly.

1. In combination with a dishwashing machine having a circulating pump for conveying a liquid and a washing receptacle with at least two spraying devices further conveying the liquid for cleaning goods disposed in the washing receptacle, a movement reversal device through which the liquid flows, the movement reversal device comprising:
at least two outlets for supplying the liquid to different ones of the spraying devices; and
a positioning element for opening or closing said outlets such that in each case either one of said outlets, a number of said outlets, or all of said outlets are opened or closed alternately one after another and/or continuously, said positioning element having at least two openings formed therein including a first opening and a second opening having a different cross-section compared to a cross-section of said first opening.

2. The movement reversal device according to claim 1, wherein said cross-section of said first opening is less than said cross-section of said second opening.

3. The movement reversal device according to claim 2, wherein said first opening supplies the liquid to one of the spraying devices being an upper spraying device.

4. The movement reversal device according to claim 1, wherein said positioning element is a disc having said first opening and at least one of said second opening formed therein, said cross-section of said second opening being greater than said cross-section of said first opening.

5. The movement reversal device according to claim 4, wherein said second opening serves substantially to supply the liquid to one of the spraying devices being a lower spraying device, but alternatively can also serve to supply the liquid to another of the spraying devices being an upper spraying device.

6. The movement reversal device according to claim 4, wherein said second opening is one of two second openings each having a cross-section greater than said cross-section of said first opening, said two second openings disposed opposing one another on said disc and serve for supplying simultaneously the liquid to the spraying devices including an upper spraying device and a lower spraying device.

7. The movement reversal device according to claim 1, wherein said positioning element has closed areas sitting tightly on corresponding ones of said outlets in a locked position, each of said closed areas having a revolving sealing edge projecting up in a direction of said outlets.

8. The movement reversal device according to claim 1, wherein said positioning element has a sealing edge surrounding said first opening and projecting up in a direction of said outlets.
